(19) United States
(12) Patent Application Publication
(10) Pub. No.: US 2003/0133650 A1
(43) Pub. Date: Jul. 17, 2003

(54) System and method of transmitting optical signals using IIR and FIR filtration

(76) Inventors: Farhad Hakimi, Watertown, MA (US); Hosain Hakimi, Watertown, MA (US)

Correspondence Address: Peter M. Dichiara, Hale and Dorr LLP, 60 State Street, Boston, MA, 02109, US

(21) Appl. No.: 10/052,868

(22) Filed: Jan. 16, 2002

(51) Int. Cl. G02B 6/26; G02B 6/34; G02B 5/20

(52) U.S. Cl. 385/27; 385/37; 385/39; 359/885

(57) ABSTRACT

Apparatus and methods for transmitting optical signals that are more tolerant to various forms of distortion inherent in transmitting optical signals over fiber are disclosed. An optical signal transmission apparatus includes a tunable filter block that receives optical signals and provides filtered optical signals. The tunable filter block includes an IIR filter and a FIR filter, at least one of which is tunable in response to a filtered signal, such as the output signal of the apparatus. Certain embodiments have a tunable IIR filter and a tunable FIR filter. The tunable IIR filter receives optical signals and creates IIR filtered signals therefrom. The received optical signals may be characterized in the frequency domain by an optical carrier having associated left and right side band spectral components. Each side band spectral component is separated from the optical carrier by a spectral distance. The optical carrier and the left and right side band spectral components each have at least two associated data side bands. The tunable IIR filter may be characterized by a predefined pass band spectral width and a center frequency, in which the center frequency is adjustable in response to a control signal. The tunable FIR filter receives time domain optical pulses and creates FIR filtered signals therefrom. Each FIR filtered signals includes the received time domain optical pulse and a time-delayed replicated version thereof. The time domain optical pulse and the replicated version thereof have a relative phase-shift therebetween, and the amount of phase-shift created by the FIR filter is adjustable in response to a control signal. Under certain arrangements, the IIR filter precedes the FIR filter.

### BACKGROUND OF THE INVENTION

1. Field of the Invention

This invention relates to improved systems and methods of transmitting optical signals.

2. Description of Related Art

Dense Wavelength Division Multiplexing (DWDM) allows a large number of information channels of optical signals to be transmitted onto a single strand of single-mode fiber. At data rates of 10 gigabits per second (Gb/s) and with current DWDM filter technology, current channel spacing is about 25 GHz (0.2 nm @ 1550 nm), meaning that the carrier frequency of one channel is separated from the carrier frequency of an adjacent channel by about 25 GHz. This means over the entire C-band of operation (30 nm), supported by current Erbium Doped Fiber Amplifier (EDFA) technology, 150 channels (or 1.5 Tb/s) of information may be transmitted over a single optical fiber.

However, linear and non-linear distortions inhibit the ability to send information at higher rates or over longer distances. As data rates increase the known problems will become more acute. In material part, linear distortions include the following:

second order chromatic dispersion

chromatic dispersion slope or third order dispersion (TOD)

polarization mode dispersion (PMD)

Non-linear problems include the following:

self phase modulation (SPM)

cross phase modulation (XPM)

four wave mixing (FWM)

For a description of these distortions one may refer to NONLINEAR FIBER OPTICS by Govind P. Agrawal or other similar references.

To date, dispersion compensating fibers (DCFs) have been used to help address second order chromatic dispersion, but adequate solutions to the other problems have been lacking or undesirable. For a description of DCFs one may refer to, among others, C. Lin et al., “Optical Pulse Equalization and Low-Dispersion Transmission in Single Mode Fibers in the 1.3-1.7 μm Spectral Region” Opt. Lett., vol. 5, p. 476, 1980 and J. M. Dugan et al., “All-optical, Fiber-based 1550 nm Dispersion Compensation in a 10 Gbits/s, 150 km Transmission Experiment Over 1310 nm Optimized Fiber,” OFC '92, San Jose Calif., 1992, post deadline paper PD14. For example, attempts have been made to address SPM using lower input power for the signal and using a Raman amplifier. Lowering input power, however, impairs signal to noise quality, and the use of Raman amplifiers increases the cost and complexity of the overall system.

There is therefore a need for a system and method to address the above distortions.

### SUMMARY

The invention provides apparatus and methods for transmitting optical signals that are more tolerant to various forms of distortion inherent in transmitting optical signals over fiber.

According to one aspect of the invention, an optical signal transmission apparatus includes a tunable filter block that receives optical signals and provides filtered optical signals. The tunable filter block includes an IIR filter and a FIR filter, at least one of which is tunable in response to a filtered signal, such as the output signal of the apparatus.

According to another aspect of the invention, the tunable filter block includes a tunable IIR filter and a tunable FIR filter. The tunable IIR filter receives optical signals and creates IIR filtered signals therefrom. The received optical signals may be characterized in the frequency domain by an optical carrier having associated left and right side band spectral components. Each side band spectral component is separated from the optical carrier by a spectral distance. The optical carrier and the left and right side band spectral components each have at least two associated data side bands. The tunable IIR filter may be characterized by a predefined pass band spectral width and a center frequency, in which the center frequency is adjustable in response to a control signal. The tunable FIR filter receives time domain optical pulses and creates FIR filtered signals therefrom. Each FIR filtered signals includes the received time domain optical pulse and a time-delayed replicated version thereof. The time domain optical pulse and the replicated version thereof have a relative phase-shift therebetween, and the amount of phase-shift created by the FIR filter is adjustable in response to a control signal.

According to another aspect of the invention, the IIR filter precedes the FIR filter.

### BRIEF DESCRIPTION OF THE DRAWINGS

In the Drawing,

FIGS. 1A-B are system diagrams of exemplary transmitter apparatus that provide IIR filtration according to certain embodiments of the invention;

FIGS. 2A-C are diagrams of spectral components for an optical carrier, modulated pulse sidebands, and data side bands in the frequency domain;

FIGS. 3-5 are system diagram of certain embodiments of transmission apparatus that provide IIR filtration according to certain embodiments of the invention;

FIGS. 6A-C are system diagrams of an exemplary transmitter apparatus that provides FIR filtration according to certain embodiments of the invention;

FIG. 7 is a diagram illustrating pulse reshaping according to certain embodiments of the invention;

FIGS. 8-9 are system diagrams of certain embodiments of transmission apparatus that provide FIR filtration according to certain embodiments of the invention;

FIGS. 10-17 are system diagrams of certain embodiments of transmission apparatus that provide IIR and FIR filtration according to certain embodiments of the invention;

FIGS. 18-20 are system diagrams of an exemplary transmitter apparatus according to certain embodiments of the invention in which the transmitter operates as a slave to filtered optical signals;

FIGS. 21-23 are system diagrams of an exemplary transmitter apparatus according to certain embodiments of the invention in which the transmitter operates as a slave to filtered optical signals and in which filtration components are also tunable; and

FIGS. 24-25 are system diagrams of an exemplary transmitter apparatus according to certain embodiments of the invention in which one but not all of the filtration components are tunable.

FIG. 26 is a system diagram of an exemplary transmitter apparatus according to certain embodiments of the invention in which filtration components are passive.

### DETAILED DESCRIPTION

The present invention provides improved systems and methods of transmitting optical signals. Among other things, preferred embodiments address linear and non-linear distortions and improve spectral efficiency by reshaping optical pulses (whether in RZ or NRZ format) in the frequency and/or time domains so that the pulses are more tolerant to dispersion and nonlinear distortions. The reshaped optical pulses helps suppress the dispersion slope (TOD) and channel cross-talk. Additionally, the shape of the pulse makes it more resilient to effects of PMD.

Certain embodiments filter optical signals with a tunable IIR filter. Other embodiments filter optical signals with an FIR filter. Still other embodiments filter optical signals with a combination of IIR and FIR filtration. Some embodiments have the filters act as slaves to the filtered optical signals, for example, to tune the filtration to a potentially wandering center frequency. Some embodiments have the transmitter act as a slave to the filtered optical signal.

### IIR Filtration

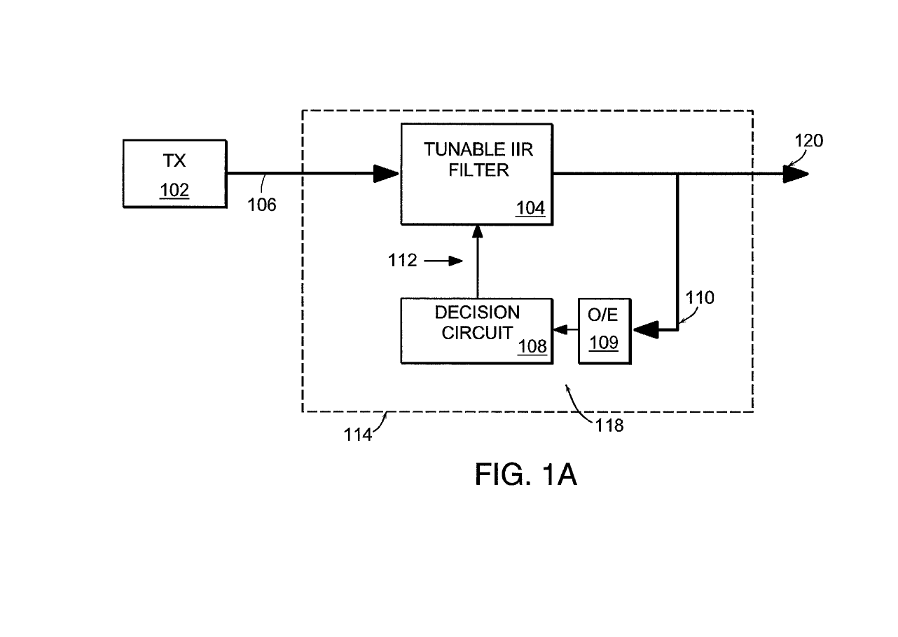

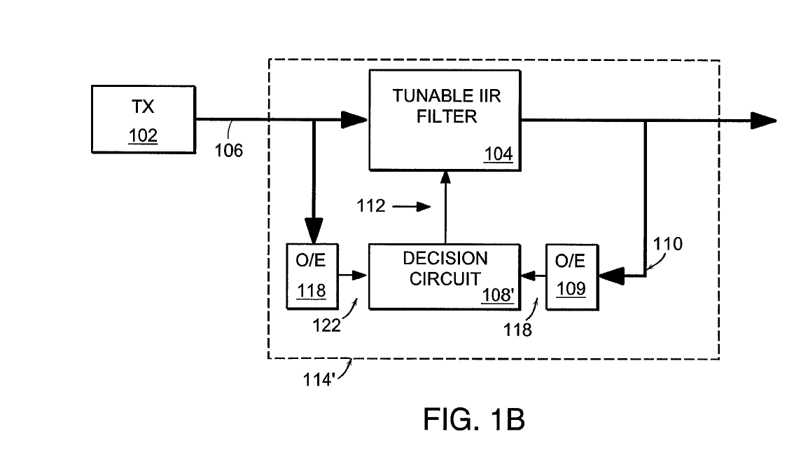

FIG. 1A shows a relevant portion of an optical signal transmission apparatus according to certain embodiments of the invention. In this arrangement, the transmission apparatus 114 follows a conventional transmitter Tx 102, and the apparatus 114 filters the signal from the transmitter 102 to reshape the spectrum of the pulses emitted therefrom and to provide the filtered signals on optical link or fiber 120. The apparatus operates as a slave to the filtered, transmitted optical signal, as will be explained below. FIG. 1B illustrates an arrangement in which the apparatus 114′ operates analogously to that of FIG. 1A but which also considers the unfiltered signal from Tx 102 on link 106.

Referring to FIG. 1A, the apparatus, or filter block, 114 includes a tunable IIR filter 104 in optical communication with transmitter (Tx) 102 via optical link (or fiber) 106. In certain embodiments, Tx 102 is one of the transmitters in a WDM or DWDM system. Tx 102 includes an optical source (not shown) such as a laser or LED and modulation circuitry (not shown) to form optical signals and data.

The filter 104 provides spectrally reshaped optical signals on optical link 120. Though only one IIR filter 104 is shown, preferred embodiments can include multiple IIR filters per transmitter (e.g., in cascaded arrangement), and can include multiple transmitters for each fiber (e.g., one transmitter for each frequency).

The optical signals from filter 104 are fed back on optical link 110 to an optical to electrical converter (O/E) 109. (An optical tap may be used to couple links 120 and 110 with the filter 104, but is not shown in the figure to reduce clutter in the illustration.) The optical converter produces an electrical version of the optical signal received on link 110 and produces the electrical version of the signal on electrical link 118. A decision circuit 108 receives the electrical signal, processes it accordingly, and uses it to produce a control signal that is transmitted to the filter 104 via electrical link 112. As will be explained below, the control signal is used to tune the IIR filter 104.

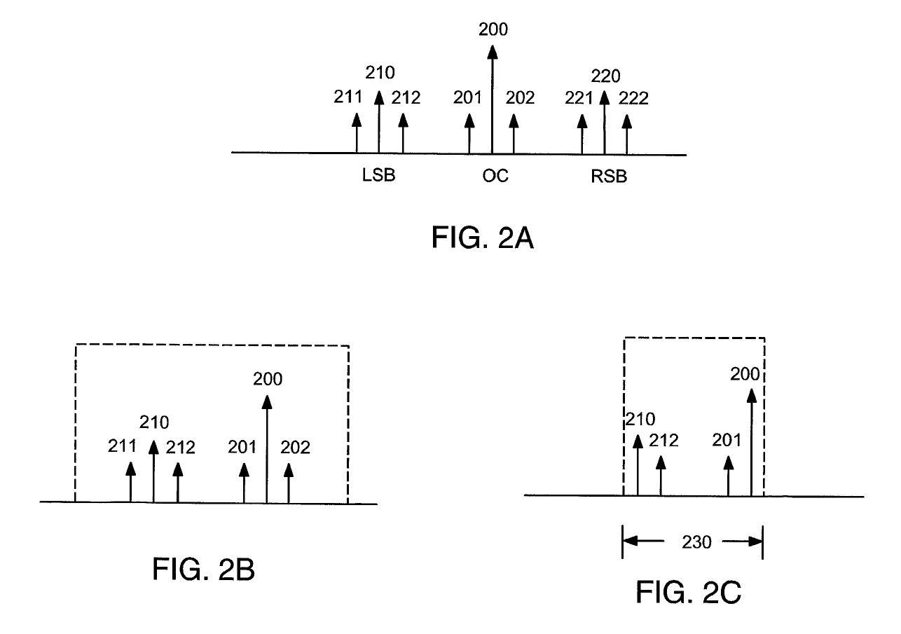

IIR filter 104 and decision circuit 108 (along with corresponding links and other components) form an active tunable filter block 114. The active filter block 114 filters the optical signals received from Tx to allow signals only within a certain pass band to be transmitted on link 120. More specifically, the filter block 114 reshapes the optical spectrum of the data pulses received by link 106 by removing side-band spectral components. This pass band and reshaping are discussed in more detail below in conjunction with the description of FIGS. 2A-C. The filter block 114 tunes to the emitted signal on link 120 so that the filter may constantly track the center frequency of the optical source in Tx 102. Thus, if the center frequency wanders, the filter tunes accordingly.

FIG. 2A illustrates the frequency spectrum of signals emitted by a conventional optical transmitter, such as Tx 102. This spectrum is formed when an optical carrier (OC) 200 is pulse modulated to create modulated spectral side bands 210 and 220 and then later modulated with data to create data side bands 211,212, 201, 202, 221, and 222. The separation between optical carrier 200 and modulated spectral side bands depends on the communication system; for example, the separation between pulse 210 and OC 200 may be about 10 GHz for a 10 Gbits/s system. The number of channels on a fiber is a function of the individual channel data rate and the overall system design.

In one embodiment, the filter block 114 removes one of the side bands; that is, either left side band (LSB), including side bands 210-212, or right side band (RSB), including side bands 220-222. For example, FIG. 2B illustrates how one embodiment would remove the RSB.

In other preferred embodiments, the filter block 114 removes more side band spectral components. FIG. 2C, for example, illustrates how one preferred embodiment removes some of the side band spectral components of the optical carrier 200 (namely pulse 202) and of LSB (namely pulse 211).

Using the example of FIG. 2C, the tunable filter block 114 is configured to have an associated spectrum width, represented by reference numeral 230. If the OC wanders, the filter block 114 will track and tune to the wandering frequency to filter out certain of the side bands, as illustrated. The remaining signals, e.g., as shown in FIG. 2C, are all that are needed at a conventional receiver for data recovery. The receiver does not need the side bands that were filtered out at the transmitter, and in fact, the receiver does not see a significant change in the time domain signal. Without loss of generality, the filter could instead remove spectral components from the LSB and data spectral components 201.

The filtering out of one of the side bands reduces the effective bandwidth or spectral width of a channel. This filtering, in turn, suppresses the temporal broadening of the pulses due to dispersion since Δτ=D*L*Δλ where Δτ is temporal spread in picoseconds (ps), D is the fiber dispersion in ps/km-nm, L is the fiber length in km, and Δλ is the spectral width in nanometers (nm). In addition, reducing the spectral width also reduces the spectral broadening caused by SPM since Δν_{f} (spectral width in frequency domain, typically measured in Hz) is proportional to n2*I*k*L*Δνi where n2 is nonlinear index in cm²/Watt, I is intensity (optical power/unit area) in Watts/cm², k is the wave number in cm⁻¹, L is fiber's length in cm, and Δν_{f} and Δνᵢ are the final and initial spectral widths respectively in Hz.

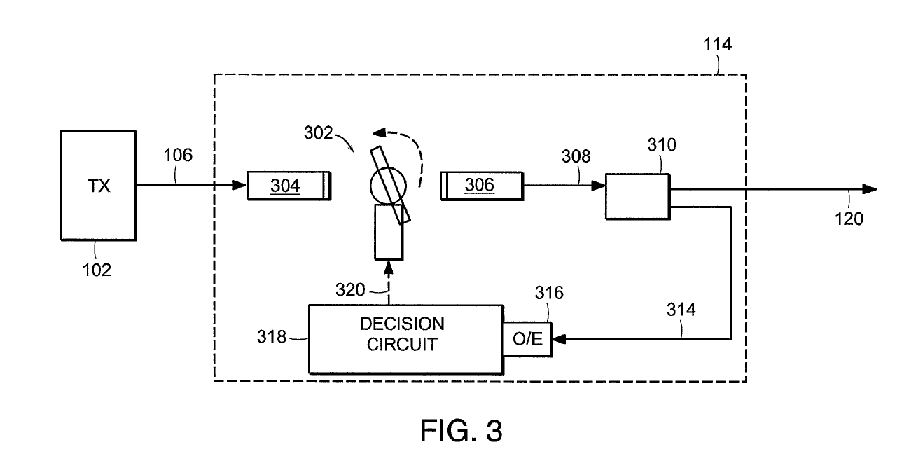

FIG. 3 shows one embodiment of the filter block 114 that utilizes a bulk optics approach (i.e., a free space beam propagation technique). In this embodiment the filter block 114 uses a high finesse Fabry perot etalon 302 (e.g., finesse greater than 10) disposed between a first collimator 304 and a second collimator 306. Optical signals are received by the first collimator 304 on link 106 and emitted toward and through etalon 302. The Fabry-Perot etalon 302 is responsible for “chopping off” the side band spectral components and establishing the pass band, allowing only certain frequencies of light to pass, centered about a “center frequency” of the positioned etalon. The filter width 230 (see FIG. 2C) is substantially fixed, as a result of the filter design, e.g., the thickness of the etalon, the optical properties of the material used, etc. The allowed band pass width is dictated by the data rates. For example, if data is sent at 10 Gb/s, then the filter width (pass band) is about 12.5 GHz; if data is sent at 40 Gb/s, the pass band is about 50 GHz (data rate* 1.25). However the center frequency of the filter can shift and be adjusted, by rotating the etalon. By rotating the etalon, the effective thickness of the etalon through which light passes changes causing the “center frequency” of the filter to shift and allowing different frequencies to pass through the etalon. In certain preferred embodiments, a multi-mirror etalon is used. Such an etalon may be used to creates a more rectangular spectral window. Collimator 306 receives the passed optical signals from the etalon and provides them on link 308 to optical tap 310. Optical tap 310 (e.g., a beam splitter) receives the “tuned” signal and provides an output signal, which may be transmitted onto an optical fiber 120, and an identical feedback optical signal on optical link 314. The output signal, once tuned, is represented by FIG. 2B or FIG. 2C. The feedback signal on link 314 is received by an optical-to-electrical converter 316, such as a photo diode detector, which then provides an electrical version of the signal to a decision circuit 318. For example, the O/E converter may generates an electric current which is converted to a voltage through use of a transimpedance amplifier. The decision circuit 318, among other things, is responsible for tuning the filter by causing the etalon 302 to rotate. Rotation may be achieved in a variety of manners, such as by a mechanical rotation stage or a stepper/gear motor for instance, controlled by a microprocessor. The control signal 320 is used to cause the etalon 302 to rotate accordingly.

The decision circuit 318 may establish tuning in many ways. For example, the circuit 318 may detect the energy or power of the feedback signal. In certain embodiments, the amount of power will be maximum when the filter is tuned as shown in FIG. 2C to capture the OC and as much of the side band spectral components as will fit within the pass band of the filter (naturally, the filter could also tune to capture the right side band spectral components, instead of the LSB spectral components.

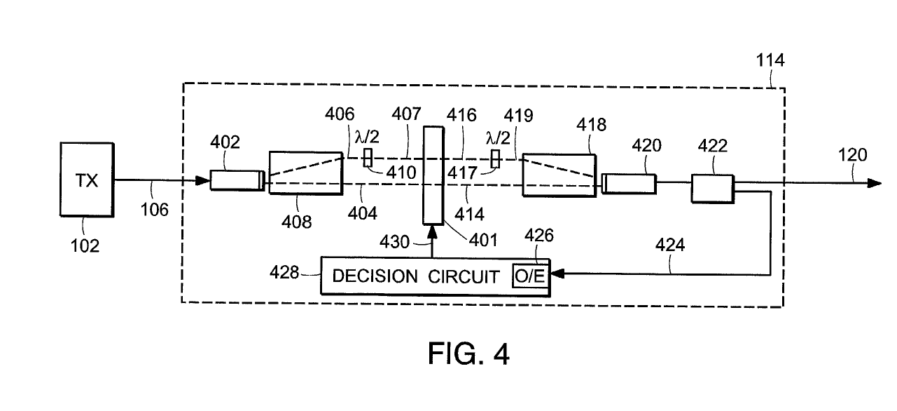

FIG. 4 illustrates another embodiment of the filter block 114. This embodiment utilizes an electronically tunable liquid crystal Fabry-Perot 401. Optical signals of arbitrary polarization are received on link 106 by first collimator 402, which then transmit the signals to first polarization beam splitter (PBS) 408 which divides the light into two paths 404, 406. Light on path 406 passes through first half wave plate 410 so that light on path 404 and 407 have states of polarization that are aligned to the optical axis of the liquid crystal cell 401. Since the liquid crystal Fabry-Perot filter 401 is a polarization sensitive element, aligning the light allows it to be tuned by the filter. The filter light is emitted as paths 414, 416 which are recombined into the output fiber using a second half wave plate 417, second PBS 418 and second collimator 420. The optical tap 422 receives the optical signal from collimator 420 and provides the output signal on link 120 and provides a feedback signal on optical link 424. The O/E 426, the decision circuit 428, and other components operate analogously to those described above. Electrical stimulus on control line 430 causes the filter 401 to change its filtration properties and thus allows the filter to track the wandering center frequency of the signals on link 106. For example, the index of refraction of the liquid crystal 401 changes in response to electrical stimulus.

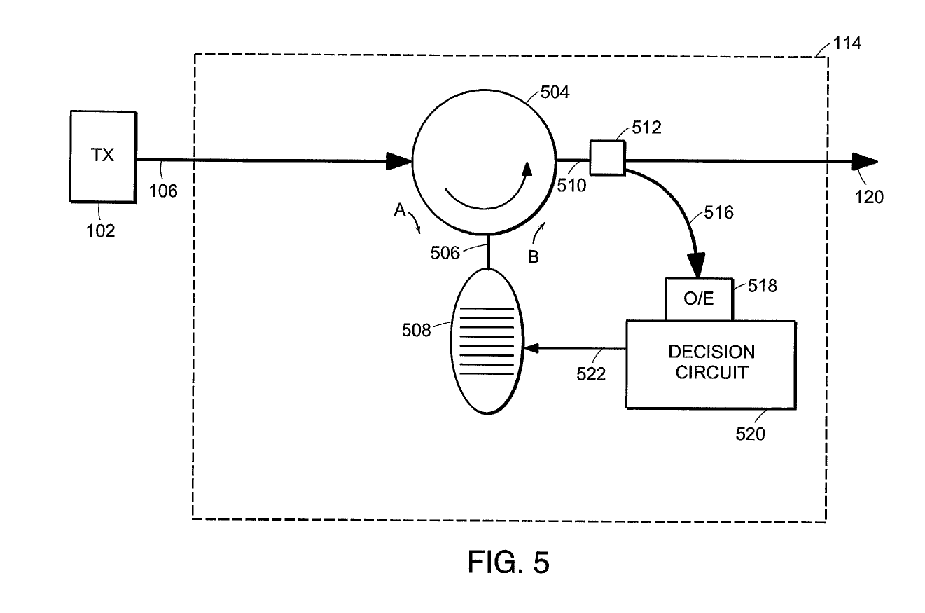

FIG. 5 shows another embodiment of the filter block 114. In this case, the filter block 114 is made using a fiber-based approach. Light is received on link 106 encounters circulator 504, which directs the received light to Fiber Brag Grating (FBG) 508, as suggested by arrow A. The grating 508 allows certain frequencies to pass and others to reflect thus acting as a pass band filter. The frequencies that pass or reflect are a function of the materials and spacing of the grating 508. Reflected light passes up link 506 and through the circulator 504, as suggested by arrow B. When light is received in this direction by the circulator 504 it is directed on link 510 to tap 512. Tap 512 provides the tuned signal to output link 120 and to link 516, as a feedback signal. O/E 518 receives the feedback signal and decision circuit 520 operates analogously to those described above. The control signal 522 from the decision circuit 520 may be used to stretch or heat the grating 508 to change the spacings and thereby cause the center frequency of the grating 508 to shift accordingly. Alternatively the arrangement of FIG. 5 could be accomplished on an integrated optics chip as well. In this case, a coupler can replace the optical circulator 504.

As outlined above, FIG. 1B shows an arrangement that operates analogously to that of FIG. 1A, but which further considers the unfiltered output of Tx 102. Embodiments such as those shown in FIGS. 3-5 may thus be modified to operate like that of FIG. 1B. The decision circuit 108 may consider the unfiltered output from the Tx 102 for several reasons. For example, if the power from Tx 102 fluctuates or changes, the power of the optical circuit (i.e., the feedback signal) may change even though the center frequency of the OC has not changed. If the decision circuit did not consider this change in power from Tx, it might try to tune the filter even though the center frequency has not changed or wandered. By considering the unfiltered output from Tx 102, the decision circuit may determine that a change in power at the feedback signal does not warrant tracking of the OC (i.e., that the change in power is due to changes in Tx power not due to changes in OC wandering).

### FIR Filtration

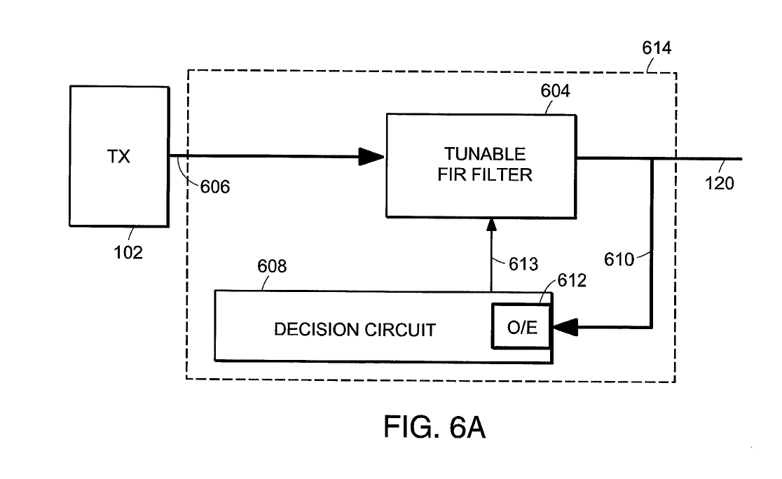

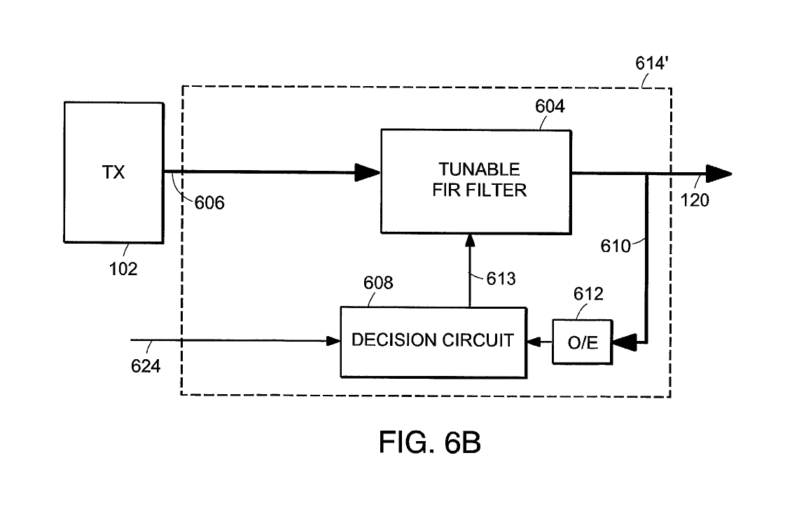

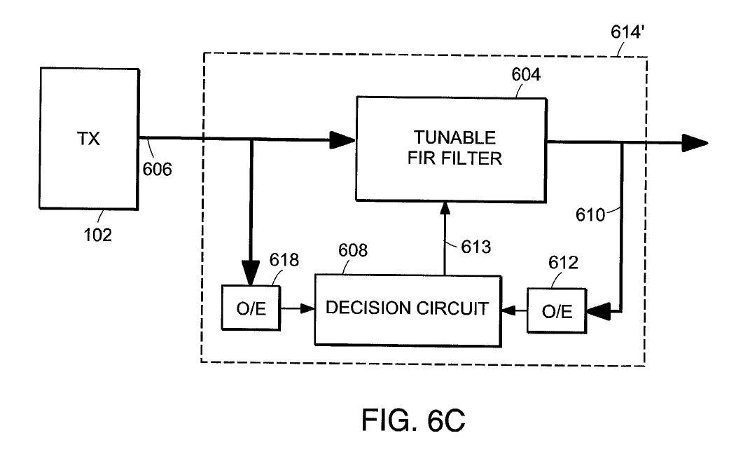

FIG. 6A shows a relevant portion of an optical signal transmission apparatus according to other embodiments of the invention. In this arrangement, the transmission apparatus 613 follows a conventional transmitter Tx 102, and the apparatus 614 filters the signal from the transmitter 102 to reshape the pulses emitted therefrom on optical link 120. The apparatus operates as a slave to the filtered, transmitted optical signal, as will be explained below. FIG. 6B illustrates an arrangement that operates analogously to that of FIG. 6a but which further considers a feedback signal 624 (e.g., an error signal) from a receiver or the like. FIG. 6C illustrates an arrangement in which the apparatus 614″ operates analogously to that of FIG. 6A but which also considers the unfiltered signal from Tx 102 on link 106.

Referring to FIG. 6A, Tx 102 is one of the transmitters in a WDM or DWDM system like those described above. Tunable FIR filter 604 is in optical communication with Tx 102 via link 606 and is in optical communication with decision circuit 608 via link 610 and optical to electrical converter 612. The decision circuit 608 is in electrical communication with FIR filter 604 via electrical link 613. The control signal carried on link 613 is used to tune the FIR filter 604. Though only one FIR filter 604 is shown, certain embodiments may utilize a plurality of such filters (e.g., cascaded) per transmitter. Moreover, each fiber 120 may be associated with multiple transmitters (e.g., one transmitter for each frequency).

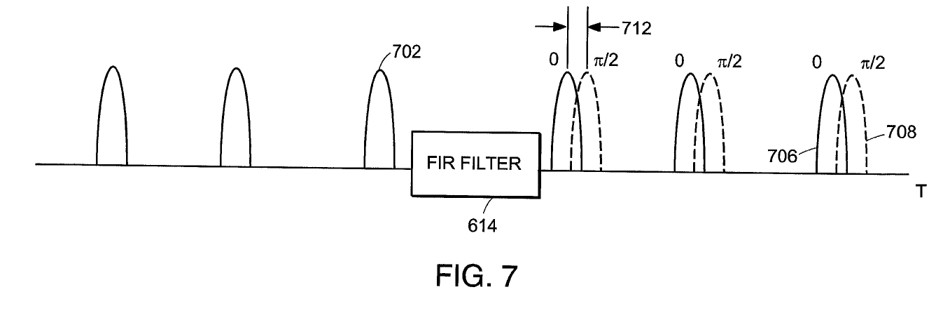

The tunable FIR filter 604 of the filter block 614 reshapes the individual pulses received on link 606 by replicating the received pulse and phase shifting it accordingly. Referring to FIG. 7, a received pulse 702 is replicated into two pulses 706 and 708. The one pulse 708 is phase shifted relative to the other. In this illustrated example, the phase shifting is about π/2. Phase shifting by ±π/2 is believed to be desirable to improve tolerance to non-linearities. Phase shifting by ±π is believed to be desirable to improve tolerance to PMD. Other amounts of phase shifting may also be beneficial. The delay 712 between these crest pulses could be as long as one half to one full width half max pulse width (FWHM).

In short, the time delay reduces the spectral width of the pulse while the phase attenuates the data side bands. This improves the pulse's dispersive and nonlinear tolerances. By replicating and phase shifting a pulse, the resulting pulse is effectively a wider or longer pulse in the time domain. By being longer in the time domain, the same pulse is narrower in the frequency domain. The pulses are reshaped so that there is overlap between the pulse pairs. Due to interference, as the phase changes the output power emerging from the FIR filter may go through minima and maxima. Thus, by monitoring power, the decision circuit may tune the phase. For example, in certain embodiments, the decision circuit attempts to maximize the power in the monitored signal by adjusting the phase.

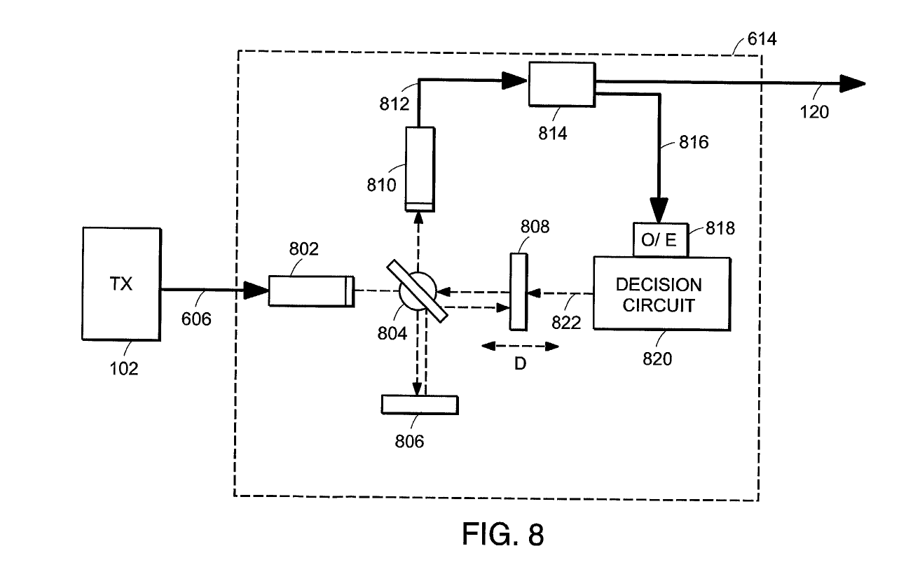

FIG. 8 shows one embodiment of the filter block 614 following a bulk optics approach. In this embodiment, the filter block 614 is implemented with a Michelson interferometer and includes a first collimator 802, beam splitter 804, fixed mirror 806, movable mirror 808, second collimator 810, O/E 818 and decision circuit 820.

The first collimator receives the optical signal on link 802 and transmits a collimated version of the signal to beam splitter (BS) 804. The beam splitter cause the signal to split, with one version proceeding toward fixed mirror 806 and another toward movable mirror 808. Each mirror causes the signal to reflect back toward the beam splitter 804. Each of the reflected versions is caused by the beam splitter to proceed toward second collimator 810. As is apparent from the system architecture, the beam splitting and subsequent recombination creates the replicated version of the input pulse signal. The different displacements of each mirror, relative to the beam splitter, causes the time delay 712 of the replicated versions of the signal. The amount of movement of the mirror causes the phase shift of one signal relative to the other. The second collimator provides the received pulses to tap 814 via optical link 812. The tap 814 provides the reshaped pulses on output link or fiber 120, and it also provides another version of the output signal as a feedback signal on optical link 816. The feedback signal is received by O/E converter 818 which provides the electrical version of the signal to decision circuit 820. The decision circuit produces control signal 822 which may cause moving mirror 818 to move in the direction D according to piezoelectric movement or the like. The phase is adjustable by the moving mirror. As the center frequency of the transmitter 102 shifts, the power in the output signal changes. The decision circuit detects these changes and commands the mirror 808 to adjust the phase to compensate the transmitter frequency shift.

Analogously to the situation with IIR filtration, a filter block 614 may be realized using electronically tunable Liquid crystal FIR filters which are Fabry-Perots of low finesse akin to the architecture shown in FIG. 4. For example, the finesse of the Fabry-Perot may be about 4 or lower. For example, the electric field applied to the crystal can change the index of refraction of the crystal and cause a corresponding phase shift.

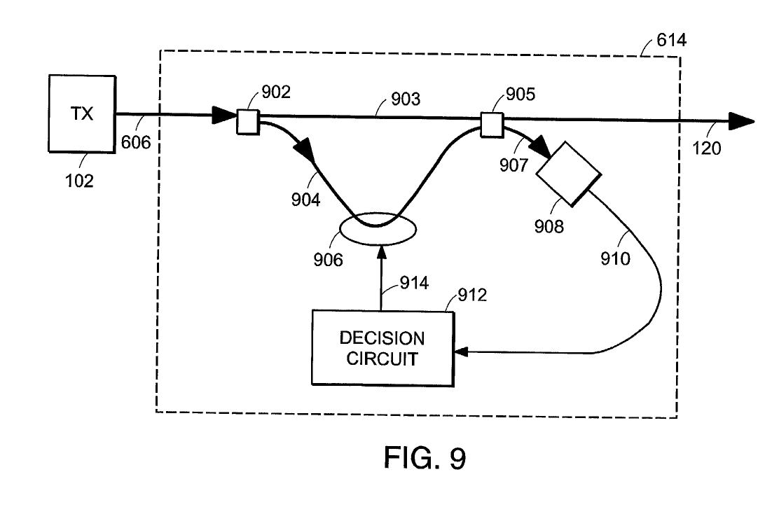

FIG. 9 shows another embodiment of filter block 614. This embodiment uses a Mach-Zehnder type interferometer. The optical signal from Tx 102 is received by tap or coupler 902, which provides the signals on optical links 903 and 904. Link 904 is responsive to phase shifter 906 and is longer than link 903. Links 903 and 904 feed coupler 905 which provides output signals on link 120 and a feedback signal on optical link 907. The feedback signal on link 907 is provided to O/E 908, which provides an electrical version thereof to decision circuit 912 via electrical link 910. The decision circuit may consider the power in the feedback signal of link 910 and cause the phase shifter to tune accordingly via control signal 914. The time delay between replicated signals is largely fixed as a result of the longer link 904, and the phase may be adjusted by phase shifter 906. Any shift in transmitter frequency is detected through the second leg 907, and the decision circuit changes the phase appropriately. The phase change or shifting may be made via a heating element (in glass wave-guides) or an electrode (in Lithium Niobate).

As outlined above FIG. 6B shows an arrangement which operates analogously to that of FIG. 6A but which further considers a feedback signal from a receiver. Embodiments such as those shown in FIGS. 8-9 may be modified to operate like that shown in FIG. 6B. The decision circuit 608 may consider the feedback signal 624 for several reasons. For example, the decision circuit may tune the phase until the receiver reports the least error. The feedback signal 624 may be provided by a low speed or unused channel or by any of a variety of forms of communication, including via software commands to a driver program.

As outlined above, FIG. 6C shows an arrangement that operates analogously to that of FIG. 6A, but which further considers the unfiltered output of Tx 102. Embodiments such as those shown in FIGS. 8-9 may thus be modified to operate like that of FIG. 6A. The decision circuit 608 may consider the unfiltered output from the Tx 102 for several reasons. For example, if the power from Tx 102 fluctuates or changes, the power of the optical circuit (i.e., the feedback signal) may change even though the center frequency of the OC has not changed. If the decision circuit did not consider this change in power from Tx, it might try to tune the filter even though the center frequency has not changed or wandered. By considering the unfiltered output from Tx 102, the decision circuit may determine that a change in power at the feedback signal does not warrant tracking of the OC (i.e., that the change in power is due to changes in Tx power not due to changes in OC wandering).

### IIR and FIR Filtration

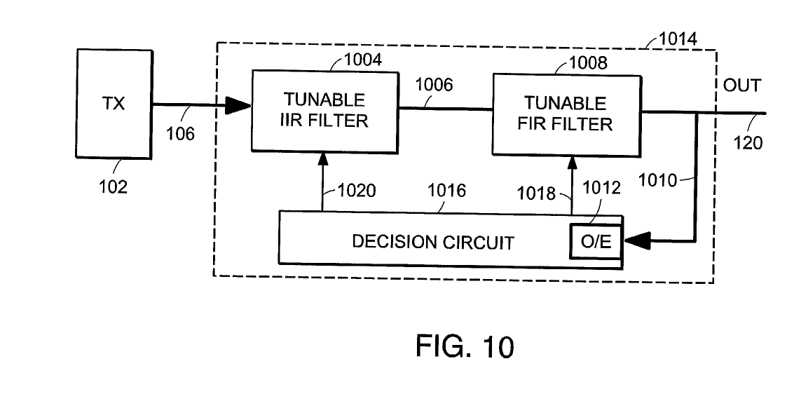

FIG. 10 shows a relevant portion of an optical signal transmission apparatus according to other embodiments of the invention. In this arrangement, the transmission apparatus 1014 follows a conventional transmitter Tx 102, and the apparatus 1014 filters the signals from the transmitter 102 to reshape the pulses emitted therefrom on optical link 120. The signals are reshaped both with IIR filtration to remove side band spectral components as discussed above, and to reshape the remaining pulses with FIR filtration as discussed above.

More specifically, optical signals are received from Tx 102 on link 106. IIR filter 1004 then removes side band spectral components as discussed above in connection with FIGS. 2B and 2C. IIR filter 1004 may be tuned in response to control signal 1020 from decision circuit 1016 to track a wandering center frequency of transmitter 102, as discussed above. FIR filter 1008 receives the remaining pulses and causes them to be replicated, delayed and phase shifted as discussed above. It may be tuned in response to control signal 1018 from decision circuit 1016, as discussed above. Though this arrangement and the ones that follow illustrate the IIR filter preceding the FIR filter, the order may be reversed. Moreover, like the embodiments above, each of the filters are shown as one entity but may be realized in a cascaded arrangement as well.

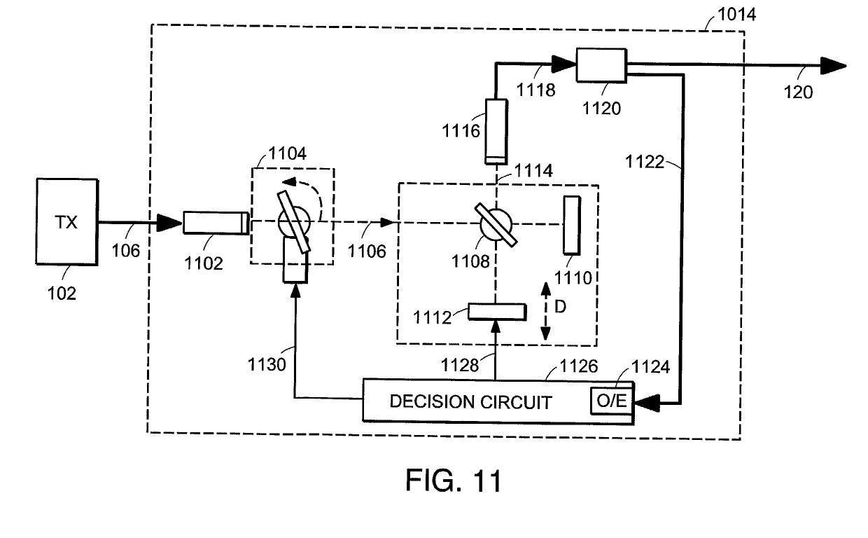

FIG. 11 shows one embodiment of the filter block 1014. The filter block is arranged first to provide IIR filtration using a tunable etalon like that described in connection with FIG. 3 and then to provide IIR filtration using Michelson interferometer like that described in connection with FIG. 8. Optical signals are received on optical link 106 by collimator 1102 which provides a collimated version of the signal to a tunable etalon 1104. The remaining pulses of the optical signal 1106 are then directed toward beam splitter 1108. The signal is split, with a portion being directed to movable mirror 1112 and another portion being directed to fixed mirror 1110. Each mirror reflects the optical signal back to beam splitter 1108 which causes the reflected versions 1114 to be directed to collimator 1116. Optical tap 1120 receives the tuned signals on optical link 1118 and provides the tuned signals on output link 120 as an output signal and on optical link 1122 as a feedback signal. O/E 1124 receives the optical feedback signal, converts the signal accordingly, and provides an electrical version thereof to decision circuit 1126. The decision circuit 1126 then may cause the movable mirror 1128 to move to adjust phase via control signal 1128 and may cause the etalon 1104 to rotate to change the center frequency of the pass band via control signal 1130.

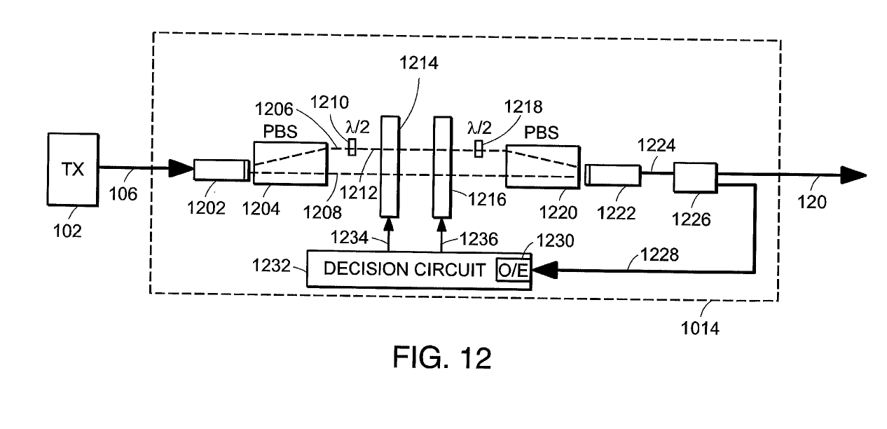

FIG. 12 illustrates another embodiment of the filter block 1014. In this example a tunable liquid crystal Fabry-Perot is used like that described in connection with FIG. 4 to provide IIR filtration, and a low finesse Fabry Perot is placed inside the polarization independent section to provide FIR filtration. Optical signals of arbitrary polarization are received on link 106 by first collimator 1202, which then transmit the signals to first polarization beam splitter (PBS) 1204 which divides the light into two paths 1206, 1208. Light on path 1206 passes through first half wave plate 1210 so that light on path 1212 and 1208 have states of polarization that are aligned to the optical axis of the liquid crystal cell 1214. The filter light is emitted from Fabry-Perot 1214 and received by low finesse Fabry-Perot 1216. The tuned light is then emitted with the light on path 1212 encountering half wave plate 1218. The light then is received by second PBS 1220, second collimator 1222, and optical tap 1226. The optical tap 1226 provides the output signal on link 120 and provides a feedback signal on optical link 1228. The O/E 1230, the decision circuit 1232, and other components operate analogously to those described above. Electrical stimulus on control line 1234 causes the filter 1214 to change its filtration properties and thus allows the filter to track the wandering center frequency of the signals on link 106. For example, the index of refraction of the liquid crystal changes in response to electrical stimulus. In addition, control line 1236 may be used to change the properties of Fabry-Perot 1216 to adjust phase shifts. The thickness of the second Fabry Perot is chosen to cause the replicated, time-delayed pulses to be produced.

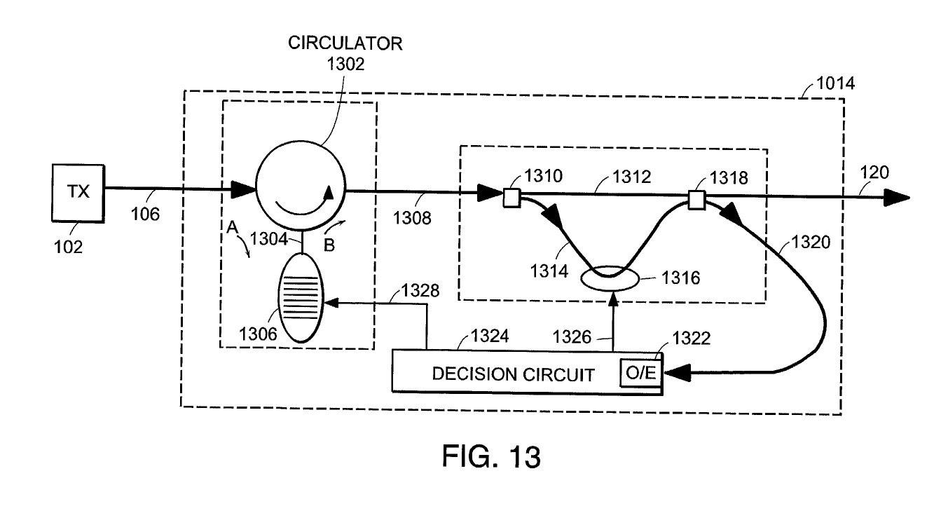

FIG. 13 illustrates another embodiment of the filter block 1014. IIR filtration is implemented using a grating like that described in connection with FIG. 5, and FIR filtration is implemented using a Mach Zehnder type interferometer like that described in connection with FIG. 9. Optical signals are received on link 106 and encounters circulator 1302, which directs the received light to grating 1306 via link 1304, as suggested by arrow A. The grating 1306 allows certain frequencies to pass and others to reflect thus acting as a pass band filter. Reflected light passes up link 1304 and through the circulator 1302, as suggested by arrow B. When light is received in this direction by the circulator 1302 it is directed on link 1308 to tap 1310. The tap or coupler 1310 provides the signals on optical links 1312 and 1314. Link 1314 is responsive to phase shifter 1316 and is longer than link 1312. Links 1312 and 1314 feed coupler 1318 which provides output signals on link 120 and a feedback signal on optical link 1320. The feedback signal on link 1320 is provided to O/E 1322, which provides an electrical version thereof to decision circuit 1324. The decision circuit may consider the power in the feedback signal and cause the phase shifter to tune accordingly via control signal 1326. (The time delay between replicated signals is largely fixed as a result of the longer link 1314.) The grating may be tuned via control signal 1328 to cause the center frequency of the pass band to track the OC of the input signal.

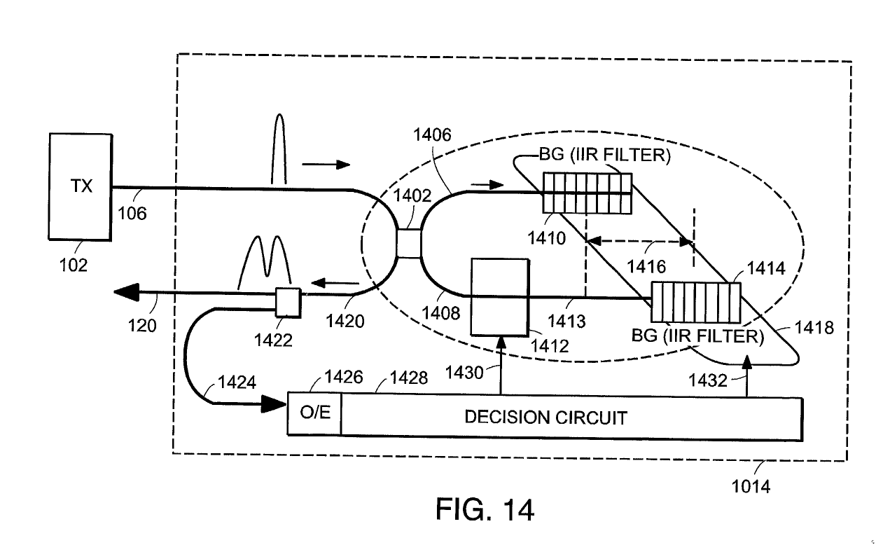

FIG. 14 illustrates another embodiment of the filter block 1014, in this case using integrated planar optics. Optical signals are received on link 106 and provided to coupler or beam splitter 1402. The coupler splits the signal and provides an optical signal on link 1406 and 1408. The signals on link 1406 are received by tunable grating 1410 which operates in reflection mode. Certain frequencies of the signal pass through grating and the frequencies of interest are reflected back on link 1406. The signals on link 1408 are first received by tunable phase shifter1412 and then provided on link 1413 where they are received by a second tunable grating 1414 which also operates in reflection mode. The reflected signal is again passed through the tunable phase shifter 1412. The reflected signals on links 1408 and 1406 are merged by coupler 1402 and provided on link 1420. Since one of the gratings 1414 has a corresponding distance of removal 1416 relative to the other grating 1410, the coupler 1402 provides a merging of two signals, one time delayed relative to the other (the time delay being a function of the distance of separation 1416). The signal on link 1420 is provided to a tap 1422, which feeds output link 120 and feedback link 1424. O/E 1426 converts the optical feedback signal to an electrical form and provides it to decision circuit 1428. The decision circuit may then tune the phase shifter 1412 via control signal 1430, using techniques like those described above, and may tune the gratings 1410, 1414 via control signal 1432, using techniques like those described above.

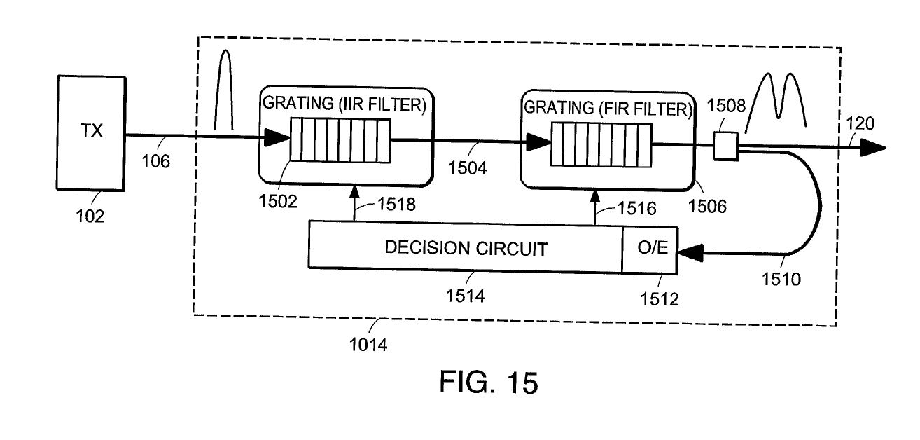

FIG. 15 shows another embodiment of filter block 1014. Optical signals are received from link 106 by grating 1502 which operates in transmissive mode to provide IIR filtration. Thus, the frequencies of interest pass through the grating on link 1504. The signal pulses on link 1504 (which has had side band spectral components removed as described above in connection with FIGS. 2B-C) are then received by a second grating 1506 which also operates in transmissive mode but to provide FIR filtration. The grating 1506 is formed or machined to create time-delayed and phase shifted versions of the pulses received on link 1504. The output signals of grating 1506 are received by tap 1508 which provides output signals on link 120 and feedback signals on link 1510. The feedback signal is received by O/E 1512 which provides an electrical version thereof to decision circuit 1514. The decision circuit 1514 may tune the phase shifting caused by grating 1506 via control signal 1516 and it may cause the center frequency of the pass band of grating 1502 to shift via control signal 1518. The second grating includes two reflective gratings with a space between them (e.g., a fiber section). Each reflective grating acts like a mirror surface with a spacing in between the two, and thus forms replicated, time-delayed pulses.

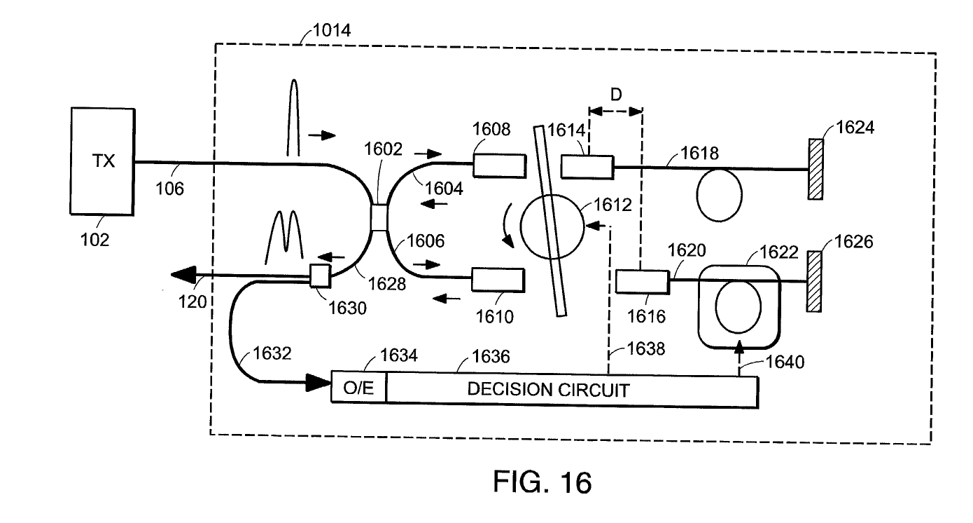

FIG. 16 shows another embodiment of filter block 1014. Optical signals are received on link 106 by coupler 1602 which splits the beam and feeds links 1604 and 1606. Signals on link 1604 are received by collimator 1608, and signals on link 1606 are received by collimator 1610. The light from each collimator 1608, 1610 then passes through rotatable etalon 1612, which allows only certain frequencies to pass, as described above. The filtered signals are then received by corresponding collimators 1614 and 1616, which are separated relative to one another by a distance D. The signals then pass through respective fibers or links 1618 and 1620. Signals on link 1620 are subjected to phase shifter 1622, and the signal on link 1618 and from phase shifter 1622 are provided to respective farrady mirrors 1624 and 1626. Phase shifter 1622 may heat or stretch the link to introduce the phase shift. The reflected signals are then provided through the phase shifter 1622 and the rotatable etalon 1612 and eventually provided by links 1604 and 1606 to coupler 1602. The merged signals are provided on link 1628 to tap 1630, which provides an output signal on link 120 and a feedback signal on link 1632. The feedback signal is received by O/E 1634 which provides an electrical version thereof to decision circuit 1636. Decision circuit 1636 may cause the etalon 1612 to rotate to track the wandering OC of signals on link 106 via control link 1638 and may cause the phase shifter 1622 to tune phase via control link 1640. In other arrangements, the mirrors may be separated by relative distances to introduce the necessary time delay.

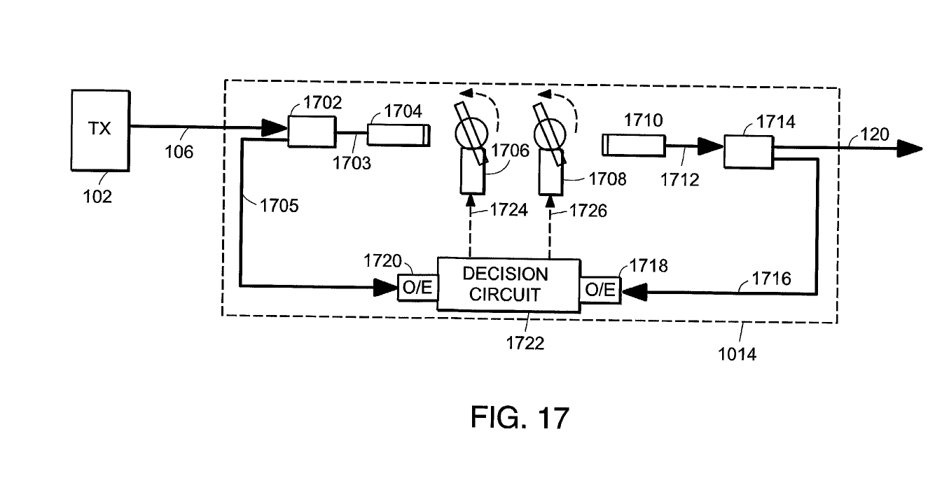

FIG. 17 shows another embodiment of filter block 1014, in this case arranged akin to FIGS. 1B and 6C. Optical signals are received on link 106 and provided to optical tap 1702. The tap 1702 provides optical signals on links 1703 and 1705. The signal on link 1705 is provided to a collimator 1704 which then provides the collimated light to first etalon 1706. The first etalon provides IIR filtration by cutting off the side band spectral components as described above. The filtered signal is then provided to second etalon 1708 which provides FIR filtration. The light from second etalon 1708 is received by collimator 1710 which provides optical signals on link 1712 to tap 1714. Tap 1714 feeds output link 120 with an output signal and also provides a feedback signal on link 1716. The signals on links 1705 and 1716 are each received by respective O/Es 1720 and 1718, each of which provides electrical versions of its input signal to decision circuit 1722. The decision circuit may then cause the first etalon to rotate via control link 1724 to track the wandering center frequency of Tx 102, and it may cause the second etalon to rotate to tune the phase of the signal vial control link 1726.

The arrangements of FIGS. 10-17 may be modified to include other forms of feedback as discussed above in connection with FIGS. 1B and 6B-C.

### Transmitter as Slave Arrangements with Passive Filtration

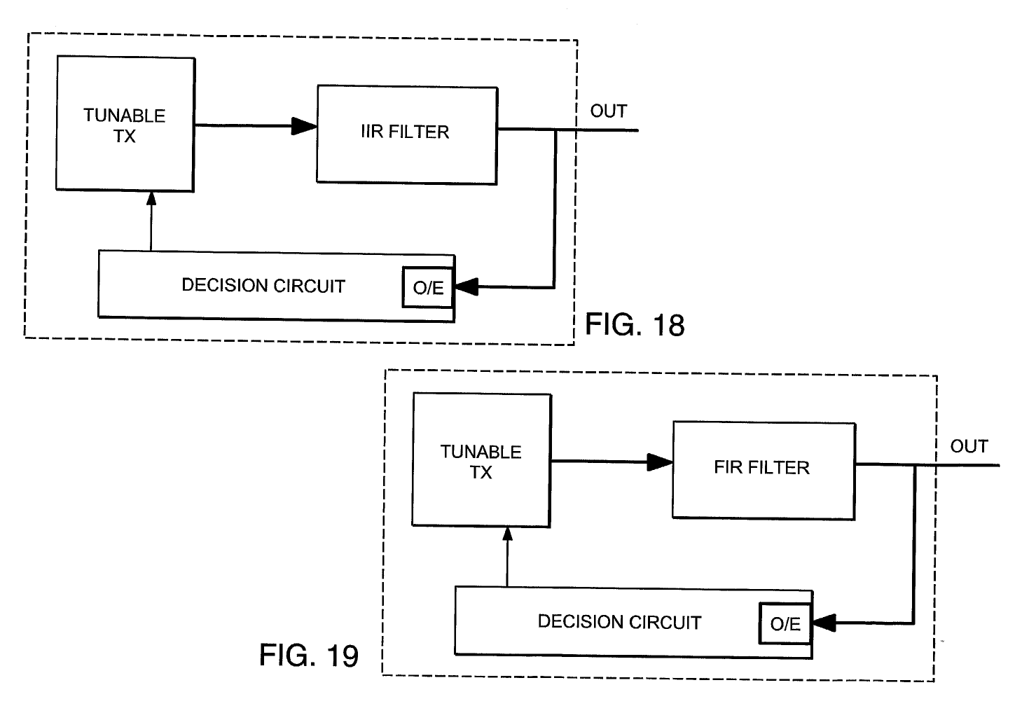

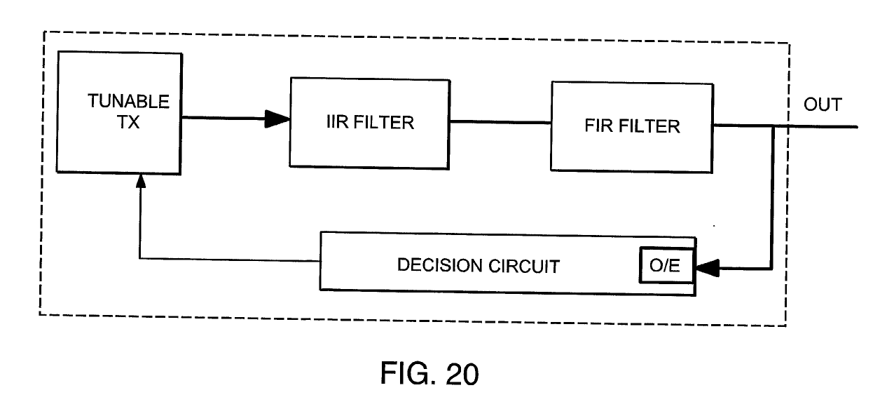

The above embodiments illustrated a transmission apparatus that operated as a slave to the output signal. Thus, if the OC frequency wandered, the filtration apparatus would tune to the changing OC. These embodiments may thus operate with conventional transmitters. However, these embodiments may be changed if the transmitters allowed feedback signals. In this case, the information used or derived by the decision circuit could be used as a feedback signal to a tunable transmitter Tx. These arrangements are shown in FIGS. 18-20. In this fashion, the IIR still filters out side band spectral components and the FIR reshapes pulses. However, the feedback signal may cause the tunable transmitter to change the frequency of OC. Likewise, since the phase is a function of the optical frequency, the feedback signal may also be used for the Tx to adjust phase.

In such arrangements, the IIR filters would be like those described above except that they need not be tunable. Thus, an IIR may be made of a high finesse multi-mirror etalon for example. Likewise, an IIR may be made of various forms of gratings whether in a bulk optics or integrated approach, e.g., FBG. FIRs may be constructed from various forms of interferometers and etalons discussed above, except that they no longer need movable mirrors or rotatable etalons. Moreover, the phase shifting components may be removed.

### Variations

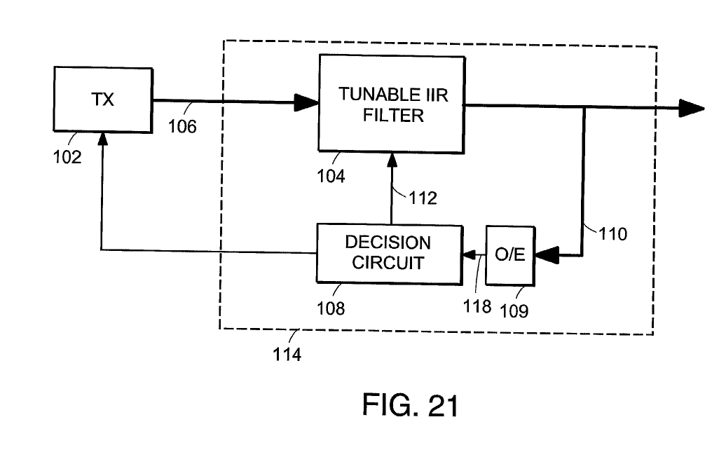

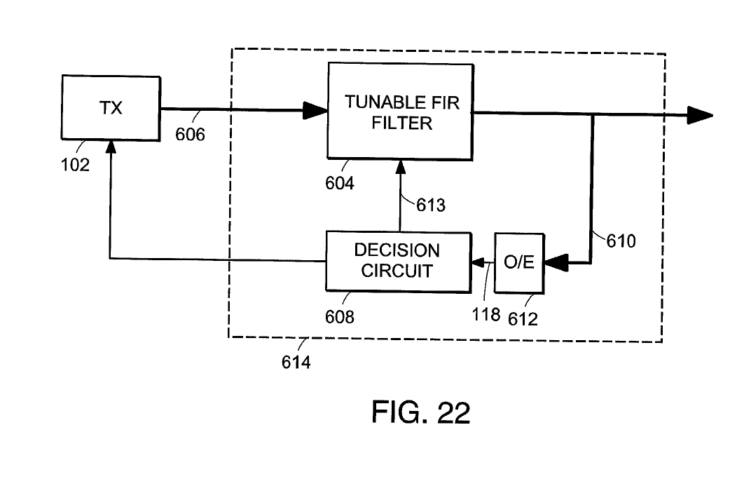

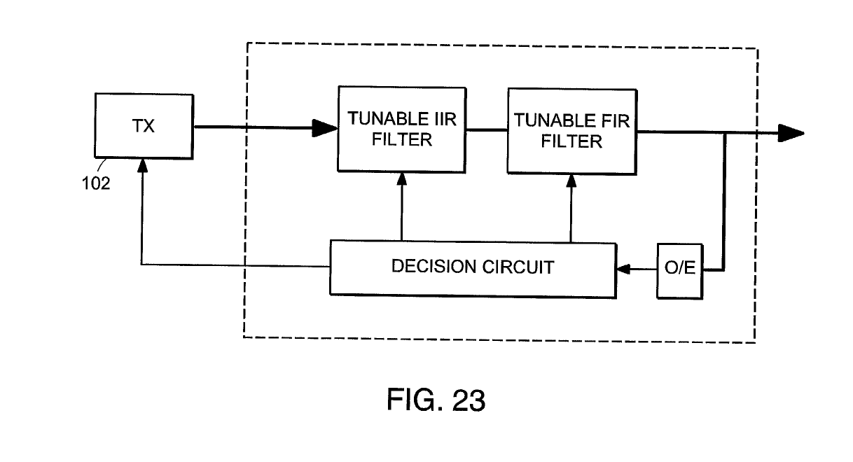

In connection with the above, the transmission apparatus may be modified in many ways. For example, a tunable IIR may still supply a feedback signal to a transmitter to adjust frequency if such transmitter permitted feedback. Thus both could cooperate. Analogously, the same arrangement may be used for tunable FIR arrangements and for arrangements having some combination of IIR and FIR, in which at least one is tunable. These arrangements are shown in FIGS. 21-23.

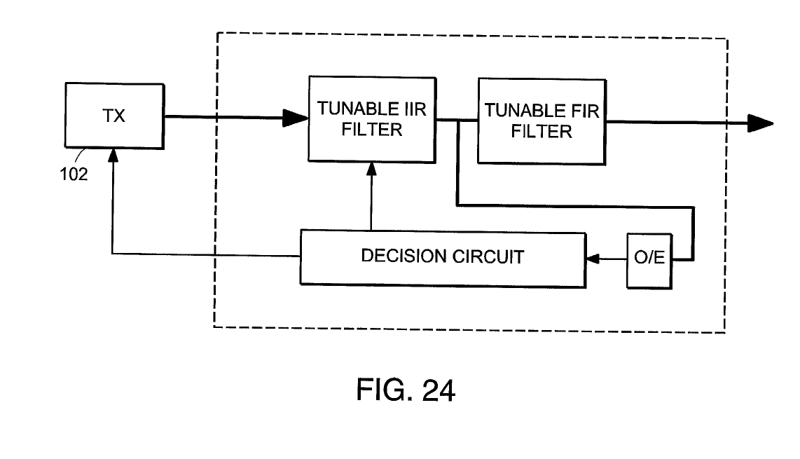

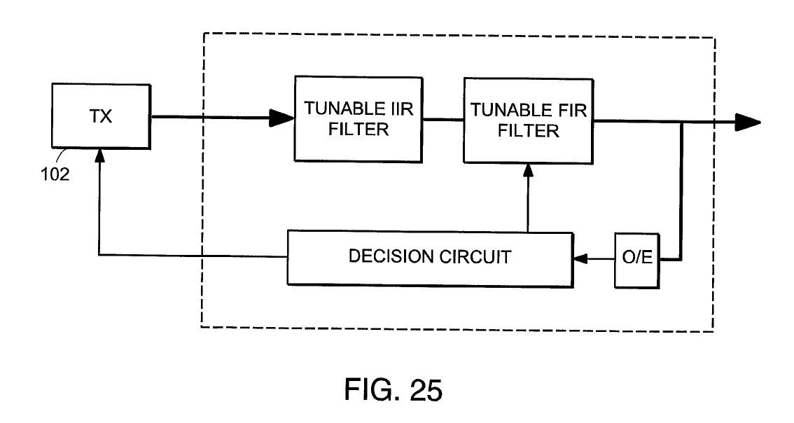

Likewise, the arrangements having an IIR and FIR may employ different arrangements. The embodiments described above had either both the IIR and FIR be tunable or passive. However, a transmission apparatus may have one be tunable and the other passive. These arrangements are shown in FIGS. 24-25. These figures suggest certain points in the apparatus for feedback to the decision circuit but others might be employed, though they are not illustrated. For example in an arrangement like FIG. 24 the decision circuit may operate off of the feedback from the FIR. In addition, these arrangements may also supply feedback to the transmitter in arrangements having transmitters that receive feedback, and their decision circuits may consider the various other signals discussed above, e.g., unfiltered signal from Tx, etc. And, as stated above the arrangement of IIR and FIR may be changed.

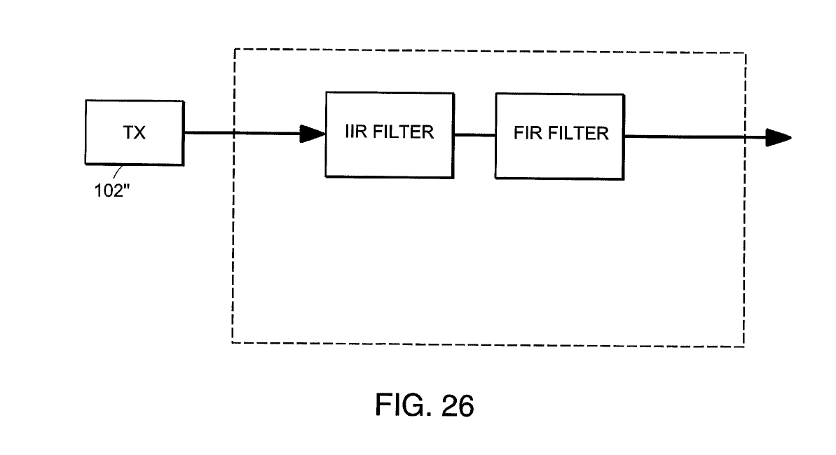

FIG. 26 shows another embodiment, particularly useful in certain arrangements. Specifically, under this embodiment, the filter block includes passive IIR and FIR filtration mechanisms as discussed above. Though illustrated with the IIR as a first stage, the order may be changed. This embodiment may be particularly useful for certain forms of transmitters Tx 102″ having internal feedback to stabilize its center frequency from wandering. For example, transmitter Tx 102″ may have a wavelength locker.

Moreover, in the above descriptions, many references were made to high and low finesse etalon filters to operate as IIR and FIR filtration devices. It will be apparent to those skilled in the art that the above arrangements may be modified in many ways. For example, the etalons may be operated in transmission mode or in reflection mode (e.g., using a coupler or circulator).

As mentioned above, the illustrated designs were shown with single filters for the most part to avoid clutter. The filters may be implemented as a cascaded arrangement of filters as well. Moreover, though not shown in the figures to avoid clutter, gaining elements may be incorporated into the design to compensate for any insertion loss from various components of the designs. For example the insertion loss of a device may be compensated by Erbium doped optical fiber amplifiers or the like. These may be placed before, after or within a filter block.

Moreover, several embodiments were described with reference to FBG gratings. These embodiments are applicable to other forms of gratings as well. For example, the grating could be formed in a fiber, or formed in an integrated optical chip.

It will be further appreciated that the scope of the present invention is not limited to the above-described embodiments, but rather is defined by the appended claims, and that these claims will encompass modifications of and improvements to what has been described.

What is claimed is:

1. An optical signal transmission apparatus, comprising:
a tunable filter block having an input link for receiving optical signals thereon and an output link for providing filtered optical signals thereon, the tunable filter block including
a tunable IIR filter that receives optical signals and creates IIR filtered signals therefrom, the received optical signals characterized in the frequency domain by an optical carrier having associated left and right side band spectral components, each side band spectral component being separated from the optical carrier by a spectral distance, and wherein the optical carrier and the left and right side band spectral components each have at least two associated data side bands, the tunable IIR filter characterized by a predefined pass band spectral width and a center frequency, the center frequency being adjustable in response to a control signal; and
a tunable FIR filter that receives time domain optical pulses and creates FIR filtered signals therefrom, each FIR filtered signal including the received time domain optical pulse and a time-delayed replicated version thereof, wherein the time domain optical pulse and the replicated version thereof have a relative phase-shift therebetween, the amount of phase-shift created by the FIR filter being adjustable in response to a control signal; and
a decision circuit, responsive to the filtered optical signals on the output link, having an output for providing control signals to the tunable filter.

2. The optical signal transmission apparatus of claim 1 wherein the tunable IIR filter receives the optical signals received by the tunable filter block and the tunable FIR filter receives the IIR filtered signals.

3. The optical signal transmission apparatus of claim 1 wherein the tunable FIR filter receives the optical signals received by the tunable filter block and the tunable IIR filter receives the FIR filtered signals

4. The optical signal transmission apparatus of claim 1 wherein the predefined pass band spectral width of the IIR filter is wide enough to capture at least the optical carrier and one of the left and right side band spectral components and is narrow enough to exclude the other of the left and right side band spectral components and its associated data side bands.

5. The optical signal transmission apparatus of claim 4 wherein the spectral width of the IIR filter is narrow enough to exclude one of the data side bands associated with the optical carrier and one of the data side bands associated with the one side band spectral component.

6. The optical signal transmission apparatus of claim 4 wherein the optical carrier has an associated frequency that can wander and wherein the decision circuit provides the control signal to adjust the center frequency of the IIR filter so that the spectral width of the filter may move to track a wandering frequency of the optical carrier.

7. The optical signal transmission apparatus of claim 5 wherein the optical carrier has an associated frequency that can wander and wherein the decision circuit provides the control signal to adjust the center frequency of the IIR filter so that the spectral width of the filter may move to track a wandering frequency of the optical carrier.

8. The optical transmission apparatus of claim 1 wherein the decision circuit analyzes the power of the filtered optical signals and provides the control signal to tune the tunable IIR and FIR filter to maximize the power of the filtered optical signals.

9. The optical transmission apparatus of claim 1 wherein the decision circuit is also responsive to optical signals received by the tunable filter block.

10. The optical transmission apparatus of claim 1 wherein the optical signals received by the tunable filter block are modulated according to a RZ format.

11. The optical transmission apparatus of claim 1 wherein the optical signals received by the tunable filter on the input link of the tunable IIR filter are modulated according to a NRZ format.

12. The optical transmission apparatus of claim 1 wherein the tunable IIR filter is a cascaded arrangement of filters.

13. The optical transmission apparatus of claim 1 wherein the tunable FIR filter is a cascaded arrangement of filters.

14. The optical transmission apparatus of claim 1 further including gaining elements to compensate for insertion loss of apparatus components.

15. The optical transmission apparatus of claim 1 wherein the tunable IIR filter is composed of bulk optics components.

16. The optical transmission apparatus of claim 1 wherein the tunable FIR filter is composed of bulk optics components.

17. The optical transmission apparatus of claim 1 wherein the tunable IIR filter is composed of integrated optics components.

18. The optical transmission apparatus of claim 1 wherein the tunable FIR filter is composed of integrated optics components.

19. The optical transmission apparatus of claim 1 wherein the tunable IIR filter is composed of fiber-based components.

20. The optical transmission apparatus of claim 1 wherein the tunable FIR filter is composed of fiber-based components.

21. The optical transmission apparatus of claim 1 wherein the tunable IIR filter includes a tunable Fabry-Perot etalon and the tunable FIR filter includes a Michelson interferometer.

22. The optical transmission apparatus of claim 21 wherein the tunable Fabry-Perot etalon is multi-mirror etalon.

23. The optical transmission apparatus of claim 1 wherein the tunable IIR filter includes a high finesse electronically tunable liquid crystal and wherein the tunable FIR filter includes a low finesse electronically tunable liquid crystal.

24. The optical transmission apparatus of claim 1 wherein the tunable IIR filter includes a tunable grating and wherein the tunable FIR filter includes Mach Zehnder interferometer.

25. The optical transmission apparatus of claim 24 wherein the tunable IIR filter further includes a circulator.

26. The optical transmission apparatus of claim 1 wherein the tunable filter block includes a coupler in optical communication with the input link, a first tunable grating in optical communication with the coupler, a tunable phase shifter in optical communication with the coupler, and a second tunable grating in optical communication with the tunable phase shifter.

27. The optical transmission apparatus of claim 26 wherein the gratings operate in reflection mode.

28. The optical transmission apparatus of claim 1 wherein the tunable filter block includes a first and second tunable grating in a series arrangement with one grating being in optical communication with the other.

29. The optical transmission apparatus of claim 1 wherein the tunable filter block includes a coupler in optical communication with the input link, a tunable etalon in optical communication with the coupler, a first mirror in optical communication with the etalon via a first fiber, and a second mirror in optical communication with the etalon via a second fiber, wherein the second fiber is responsive to a tunable phase shifter.

30. The optical transmission apparatus of claim 1 wherein the tunable IIR filter includes a high finesse tunable etalon and wherein the tunable FIR filter includes a low finesse tunable etalon.

31. The optical signal transmission apparatus of claim 1 wherein the time domain optical pulse is characterized by a full width half max (FWHM) pulse width and wherein the time delay between the time domain optical pulse and the time-delayed replication version of the FIR filtered signal is about one half the FWHM pulse width.

32. The optical signal transmission apparatus of claim 1 wherein the time domain optical pulse is characterized by a full width half max (FWHM) pulse width and wherein the time delay between the time domain optical pulse and the time-delayed replication version of the FIR filtered signal is about on e FWHM pulse width.

33. The optical signal transmission apparatus of claim 1 wherein the phase-shift between the time domain optical pulse and the replicated version thereof is about ±π/2.

34. The optical signal transmission apparatus of claim 1 wherein the phase-shift between the time domain optical pulse and the replicated version thereof is about ±π.

35. The optical transmission apparatus of claim 1 wherein the decision circuit is also responsive to an error signal from a receiver.

36. An optical signal transmission apparatus, comprising:
a tunable filter block having an input link for receiving optical signals thereon and an output link for providing filtered optical signals thereon, the tunable filter block including
a tunable IIR filter that receives optical signals and creates IIR filtered signals therefrom, the received optical signals characterized in the frequency domain by an optical carrier having associated left and right side band spectral components, each side band spectral component being separated from the optical carrier by a spectral distance, and wherein the optical carrier and the left and right side band spectral components each have at least two associated data side bands, the tunable IIR filter characterized by a predefined pass band spectral width and a center frequency, the center frequency being adjustable in response to a control signal; and
a tunable FIR filter that receives time domain optical pulses and creates FIR filtered signals therefrom, each FIR filtered signals including the received time domain optical pulse and a time-delayed replicated version thereof, wherein the time domain optical pulse and the replicated version thereof have a relative phase-shift therebetween, the amount of phase-shift created by the FIR filter being adjustable in response to a control signal.

37. A method of transmitting optical signals, comprising:
receiving from an optical signal transmitter optical signals characterized in the frequency domain by an optical carrier having associated left and right side band spectral components, each side band spectral component being separated from the optical carrier by a spectral distance and wherein the optical carrier and the left and right side band spectral components each have at least two associated data side bands, and characterized in the time domain a train of time domain optical pulses;
filtering out signal components outside of a predefined pass band spectral width centered around a center frequency;
replicating time domain optical pulses;
causing a time delay between a time domain optical pulse and a corresponding replicated time domain optical pulse;
causing a phase shift between a time domain optical pulse and a corresponding replicated time domain optical pulse;
providing as filtered optical signals a train of pairs of time domain optical pulses and corresponding time-delayed phase-shifted replicated versions thereof which in the frequency domain have had components removed that are outside of a predefined pass band spectral width centered around a center frequency.

38. The method of claim 37 further comprising analyzing the filtered optical signals and adjusting at least one of the center frequency and the amount of phase shift in response thereto.

39. The method of claim 37 further comprising analyzing the filtered optical signals and adjusting the center frequency and the amount of phase shift in response thereto.

40. The method of claim 39 wherein the act of filtering out signal components precedes the act of causing a phase shift.

41. The method of claim 39 wherein the predefined pass band spectral width is wide enough to capture at least the optical carrier and one of the left and right side band spectral components and is narrow enough to exclude the other of the left and right side band spectral components and its associated data side bands.

42. The method of claim 41 wherein the spectral width of the IIR filter is narrow enough to exclude one of the data side bands associated with the optical carrier and one of the data side bands associated with the one side band spectral component.

43. The method of claim 39 wherein the optical carrier has an associated frequency that can wander and wherein the center frequency is adjusted so that the spectral width of the predefined pass band may move to track a wandering frequency of the optical carrier.

44. The method of claim 39 wherein the filtered optical signals are analyzed to determine their power and the center frequency and the amount of phase shift are adjusted to maximize the power of the filtered optical signals.

45. The method of claim 39 wherein the received optical signals are also analyzed to determine to adjust the center frequency and phase shift.

46. The method of claim 39 wherein the received optical signals are modulated according to a RZ format.

47. The method of claim 39 wherein the received optical signals are modulated according to a NRZ format.

48. The method of claim 39 wherein the time domain optical pulse is characterized by a full width half max (FWHM) pulse width and wherein the time delay between the time domain optical pulse and the time-delayed replication version is about one half the FWHM pulse width.

49. The method of claim 39 wherein the time domain optical pulse is characterized by a full width half max (FWHM) pulse width and wherein the time delay between the time domain optical pulse and the time-delayed replication version is about one FWHM pulse width.

50. The method of claim 39 wherein the phase-shift between the time domain optical pulse and the replicated version thereof is about ±π/2.

51. The method of claim 39 wherein the phase-shift between the time domain optical pulse and the replicated version thereof is about ±π.

52. The method of claim 39 wherein an error signal from a receiver is also analyzed to adjust the center frequency and the amount of phase shift.

53. An optical signal transmission apparatus, comprising:
a tunable filter block having an input link for receiving optical signals thereon and an output link for providing filtered optical signals thereon, the tunable filter block including
an IIR filter that receives optical signals and creates IIR filtered signals therefrom, the received optical signals characterized in the frequency domain by an optical carrier having associated left and right side band spectral components, each side band spectral component being separated from the optical carrier by a spectral distance, and wherein the optical carrier and the left and right side band spectral components each have at least two associated data side bands, the IIR filter characterized by a predefined pass band spectral width and a center frequency; and
an FIR filter that receives time domain optical pulses and creates FIR filtered signals therefrom, each FIR filtered signal including the received time domain optical pulse and a time-delayed replicated version thereof, wherein the time domain optical pulse and the replicated version thereof have a relative phase-shift therebetween; and
a decision circuit, responsive to the filtered optical signals on the output link, having an output for providing control signals to at least one of IIR filter and FIR filter to adjust at least one of the center frequency and the phase-shift.

54. An optical signal transmission apparatus, comprising:
a filter block having an input link for receiving optical signals thereon and an output link for providing filtered optical signals thereon, the filter block including
an IIR filter that receives optical signals and creates IIR filtered signals therefrom, the received optical signals characterized in the frequency domain by an optical carrier having associated left and right side band spectral components, each side band spectral component being separated from the optical carrier by a spectral distance, and wherein the optical carrier and the left and right side band spectral components each have at least two associated data side bands, the IIR filter characterized by a predefined pass band spectral width and a center frequency; and
a FIR filter that receives time domain optical pulses and creates FIR filtered signals therefrom, each FIR filtered signal including the received time domain optical pulse and a time-delayed replicated version thereof, wherein the time domain optical pulse and the replicated version thereof have a relative phase-shift therebetween.

55. The optical signal transmission apparatus of claim 54 wherein the predefined pass band spectral width of the IIR filter is wide enough to capture at least the optical carrier and one of the left and right side band spectral components and is narrow enough to exclude the other of the left and right side band spectral components and its associated data side bands.

56. The optical signal transmission apparatus of claim 55 wherein the spectral width of the IIR filter is narrow enough to exclude one of the data side bands associated with the optical carrier and one of the data side bands associated with the one side band spectral component.
